(19) United States
(12) Patent Application Publication
(10) Pub. No.: US 2010/0296008 A1
(43) Pub. Date: Nov. 25, 2010

(54) LIGHTING DEVICE, DISPLAY DEVICE AND TELEVISION RECEIVER

(75) Inventors: Yasumori Kuromizu, Osaka-shi (JP); Masashi Yokota, Osaka-shi (JP); Syuki Yamamoto, Osaka-shi (JP); Kaori Yamamoto, Osaka-shi (JP)

Correspondence Address: SHARP KABUSHIKI KAISHA;C/O KEATING & BENNETT, LLP, 1800 Alexander Bell Drive, SUITE 200, Reston, VA, 20191, US

(73) Assignee: SHARP KABUSHIKI KAISHA, Osaka-shi, Osaka (JP)

(21) Appl. No.: 12/810,908

(22) PCT Filed: Oct. 21, 2008
(86) PCT No.: PCT/JP2008/069061

§ 371 Date: Jun. 28, 2010

(30) Foreign Application Priority Data
Jan. 15, 2008 (JP) 2008-006281

(51) Int. Cl. H04N 5/66; F21V 3/04; F21S 4/00; G02F 1/13357; G02F 1/1335

(52) U.S. Cl. 348/739; 362/311.01; 362/225; 362/97.1; 349/61; 348/E05.133

(57) ABSTRACT

A lighting device 12 of the present invention includes a light source 17 having a conductive portion 19 at ends thereof, an optical sheet 15 arranged on a light output side with respect to the light source 17 and a cover 20 having light blocking effect and covering the end of the light source 17. The cover 20 includes a covering portion 20z for covering the light source and an optical sheet supporting portion 20a for supporting the optical sheet 15 on a surface located on the light output side with respect to the covering portion 20z. A projection 71 projects from the optical sheet supporting portion 20a toward the middle of the light source 17.

### TECHNICAL FIELD

The present invention relates to a lighting device, a display device and a television receiver.

### BACKGROUND ART

A liquid crystal panel included in a liquid crystal display device, such as a liquid crystal television receiver, does not emit light, and thus a backlight device is required as a separate lighting device. A known backlight device such as the one in Patent Document 1 includes a plurality of backlight components, lamp holders that cover ends of the backlight components and diffuser plates disposed on the lamp holders. The lamp holders disclosed in Patent Document 1 have function for fixing the backlight components to a rear chassis and supporting optical sheets including the diffuser plates.

Patent Document 1: Japanese Published Patent Application No. 2006-235127

### Problem to be Solved by the Invention

Increasing demand for making the liquid crystal display device (or a liquid crystal television receiver) thinner and for making a frame of the device narrower, which is the recent trend in the field, demands for overall luminance improvement and uneven illumination correction of the backlight device are also increasing. The lamp holders are provided for covering the backlight components. Therefore, to improve the luminance or to correct the uneven illumination around edges, the lamp holders should have a small width so that covered areas of the backlight components are as small as possible. However, if the width is too narrow, the optical sheets including the diffuser plates cannot be adequately supported.

### DISCLOSURE OF THE PRESENT INVENTION

The present invention was made in view of the foregoing circumstances. An object of the present invention is to provide a lighting device having a configuration that can contribute to luminance improvement and uneven illumination correction around edges a while an optical sheet including a diffuser plate is adequately supported. The configuration of the lighting device also contributes to providing a thinner liquid crystal display device (or a display device). Another object of the present invention is to provide display device including such a lighting device and a television receiver including such a display device.

### Means for Solving the Problem

To solve the above problem, a lighting device of the present invention includes a light source having a conductive portion at an end thereof, an optical sheet arranged on a light output side with respect to the light source and a cover having light blocking effect and covering the end of the light source. The cover includes a covering portion for covering the light source, and an optical sheet supporting portion for supporting the optical sheet on a surface thereof located on the light output side. A projection projects from the optical sheet supporting portion toward a middle of the light source.

According to the lighting device, the cover (especially the covering portion) has a small width. This configuration contributes to luminance improvement and uneven illumination correction around edges. Namely, the cover includes the projection projecting from the optical sheet supporting portion on the surface located on the light output side of the covering portion. The optical sheet is supported by both optical sheet supporting portion and projection. Namely, the projection provides additional support for the optical sheet even when the width of the optical sheet supporting portion is small. Therefore, the optical sheet is properly supported while an area of the optical sheet supporting portion, that is, an area of the covering portion or the width of the cover is reduced as much as possible. As a result, an area covering the end of the light source is reduced and thus luminance improvement and uneven illumination correction around edges corresponding to the end of the light source can be achieved.

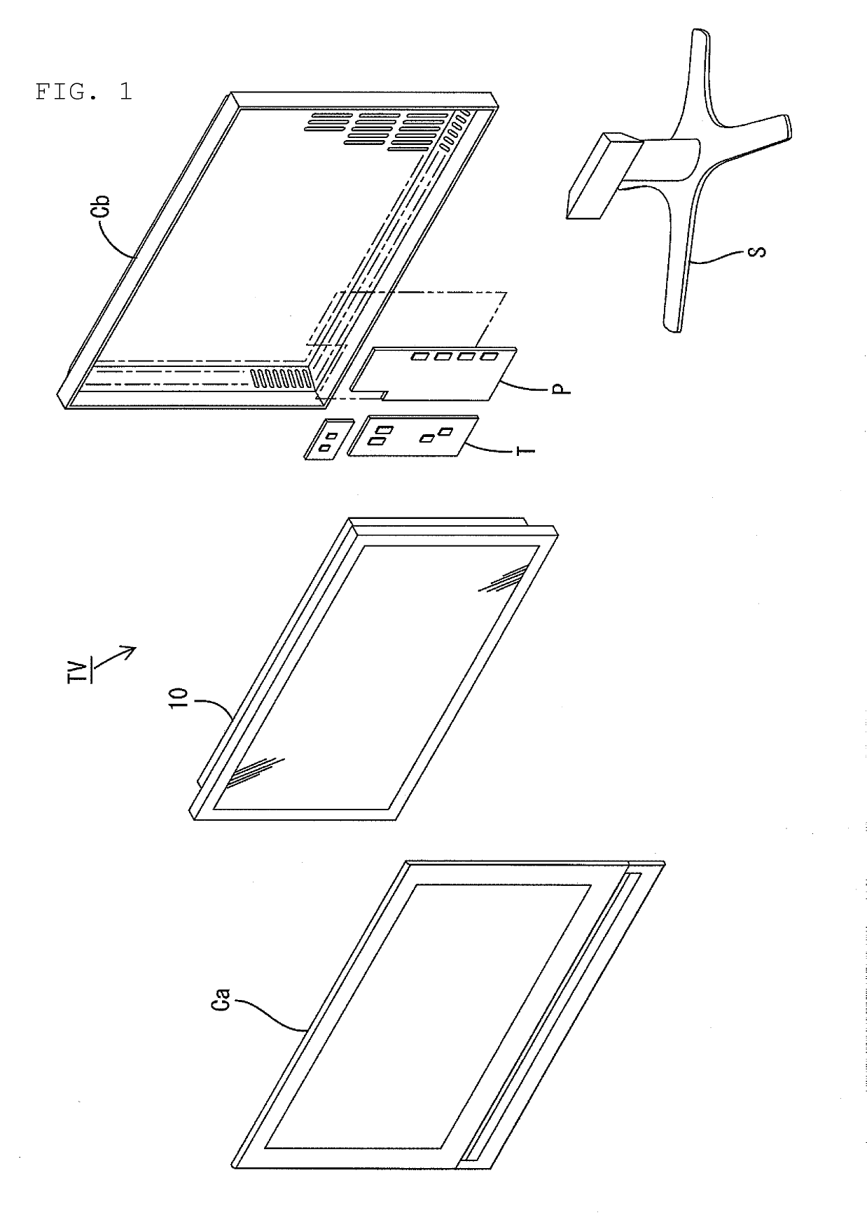

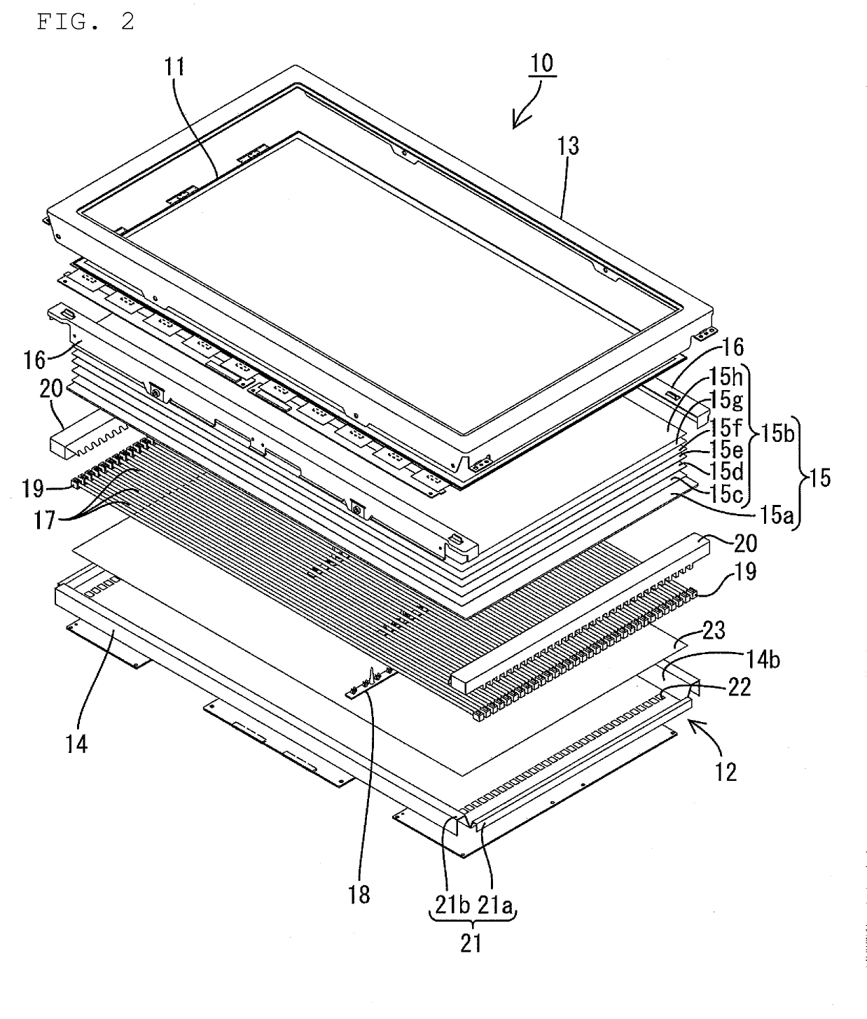

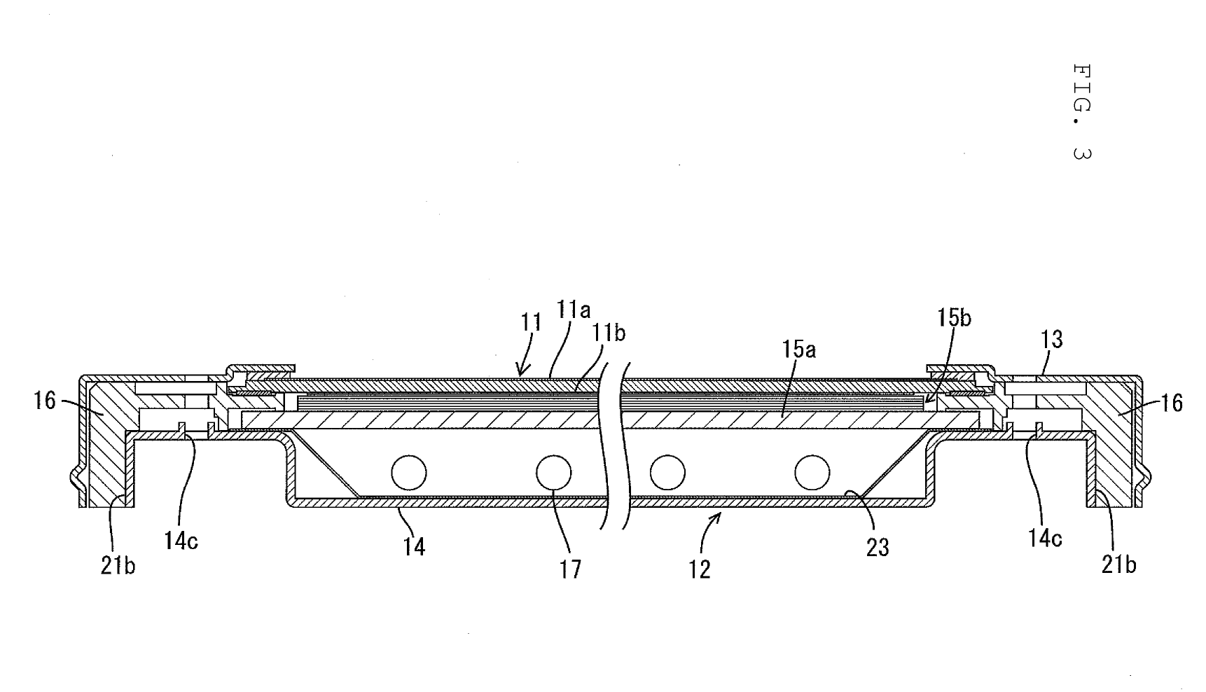

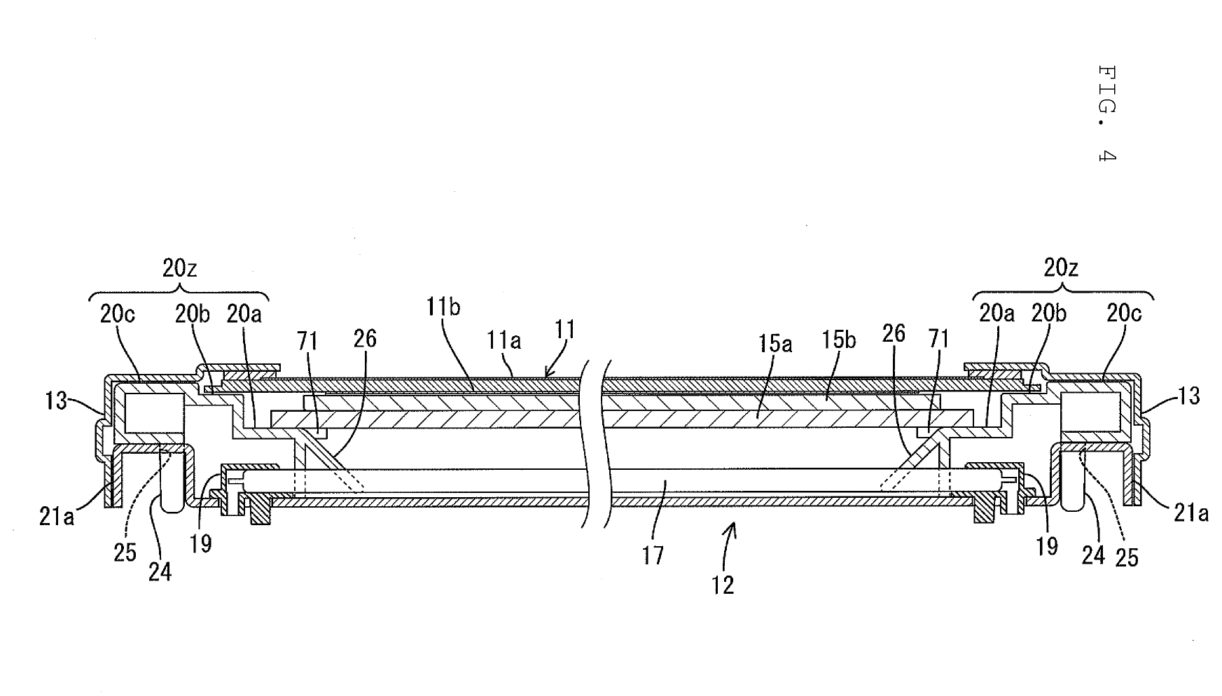

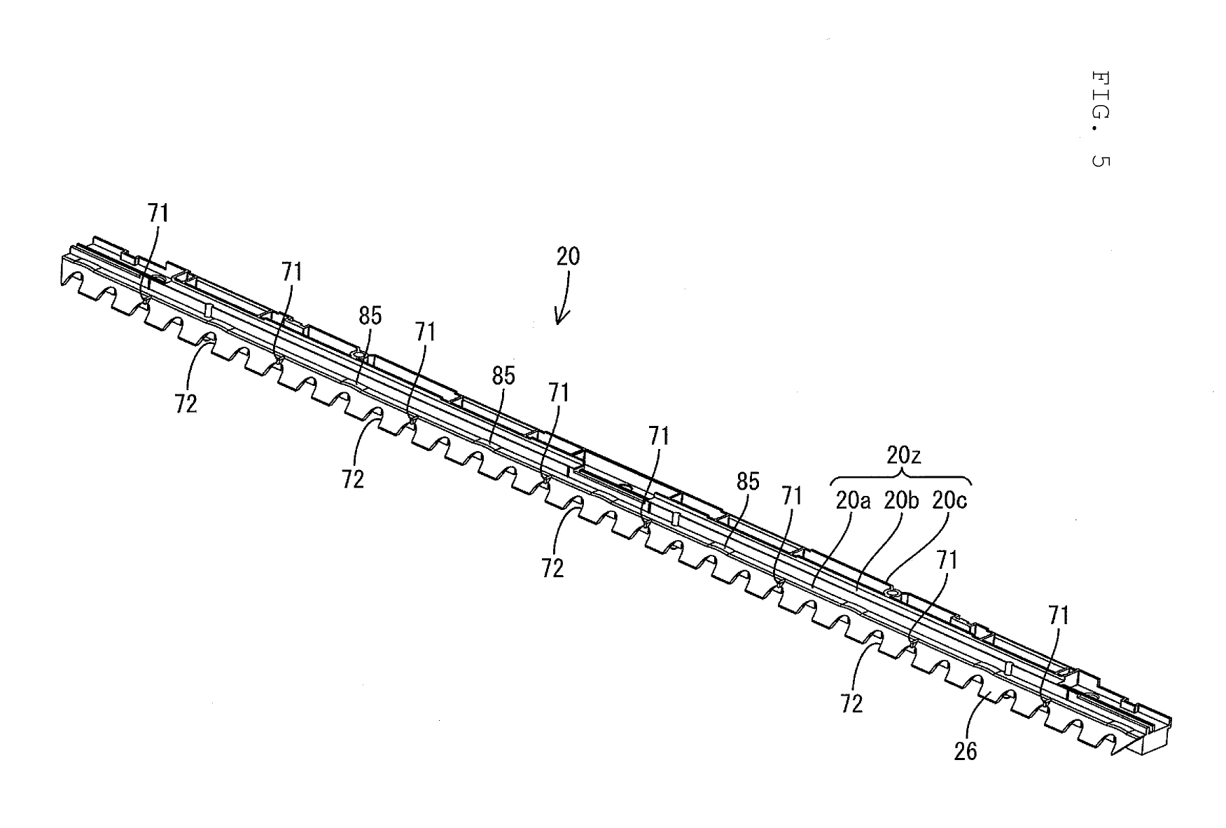

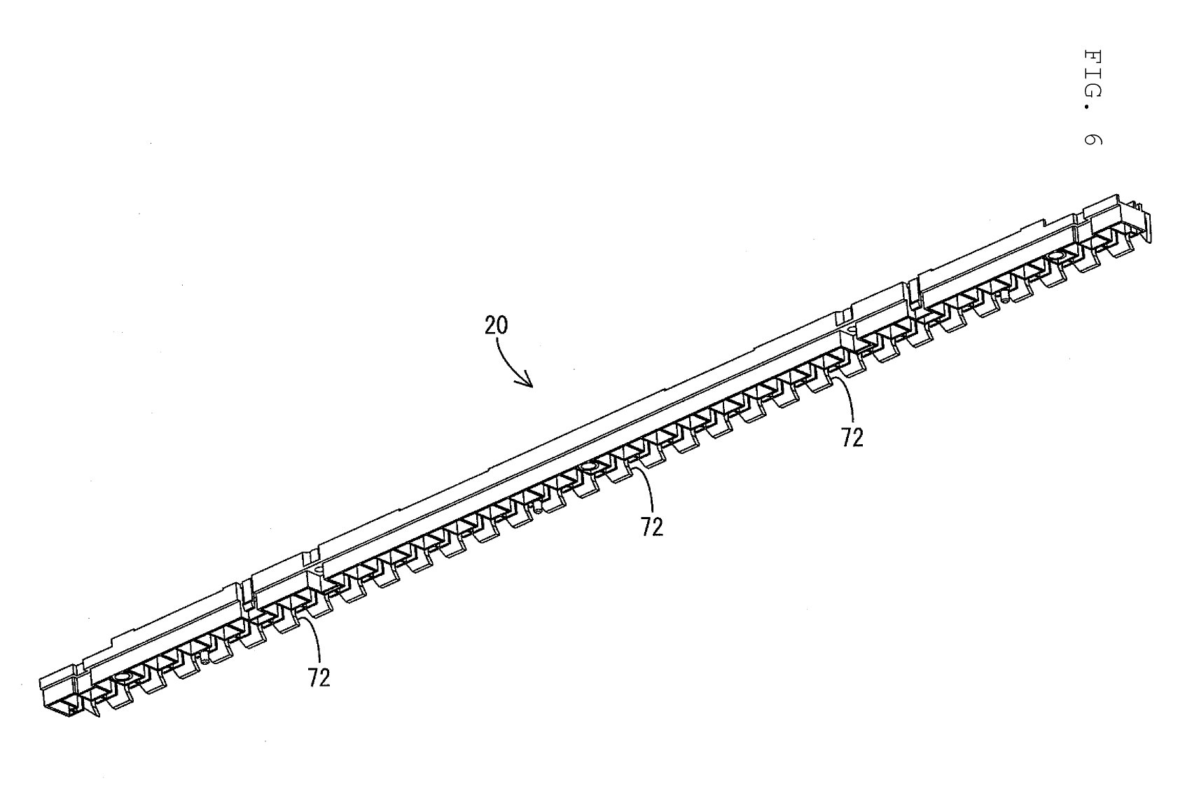

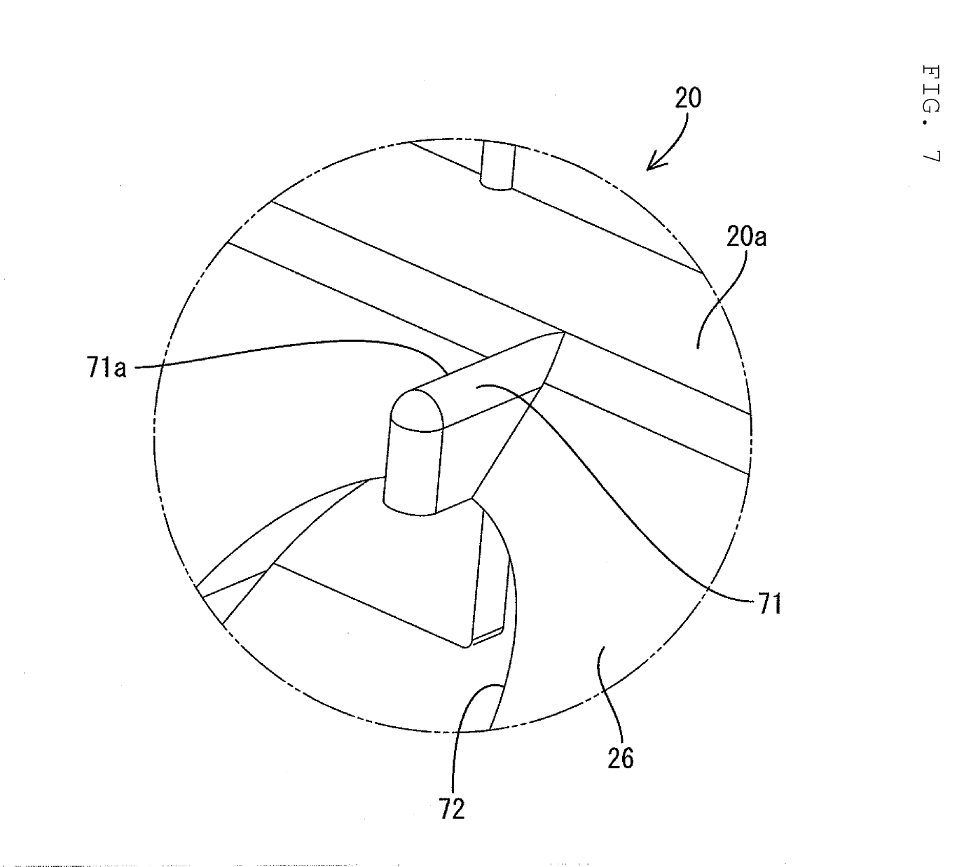

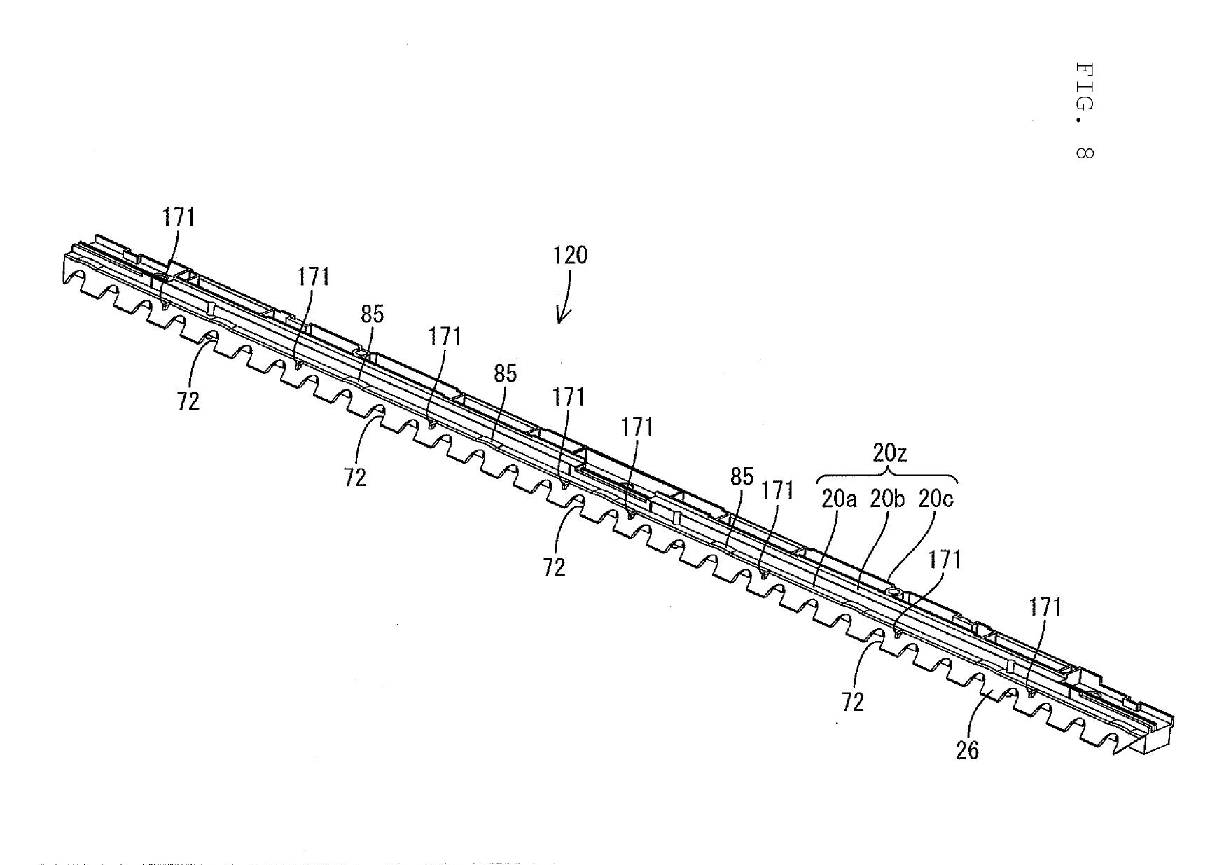

### BRIEF DESCRIPTION OF THE DRAWINGS

[FIG. 1] is an exploded perspective view illustrating a general construction of a television receiver according to an embodiment of the present invention;

[FIG. 2] is an exploded perspective view illustrating a general construction of a liquid crystal display device included in the television receiver in FIG. 1;

[FIG. 3] is a cross-sectional view of the liquid crystal display device in FIG. 2 along the short-side direction;

[FIG. 4] is a cross-sectional view of the liquid crystal display device in FIG. 2 along the long-side direction;

[FIG. 5] is a perspective view illustrating a front-side structure of a lamp holder;

[FIG. 6] is a perspective view illustrating a rear-side structure of the lamp holder;

[FIG. 7] is a magnified perspective view of a part of the lamp holder; and

[FIG. 8] is a perspective view illustrating a front-side structure of a modification of the lamp holder.

### BEST MODE FOR CARRYING OUT THE INVENTION

An embodiment of the present invention will be explained with reference to figures.

FIG. 1 is an exploded perspective view illustrating a general construction of a television receiver of this embodiment. FIG. 2 is an exploded perspective view illustrating a general construction of a liquid crystal display device included in the television receiver in FIG. 1. FIG. 3 is a cross-sectional view of the liquid crystal display device in FIG. 2 along the short-side direction. FIG. 4 is a cross-sectional view of the liquid crystal display device in FIG. 2 along the long-side direction. FIG. 5 is a perspective view illustrating front-side construction of a lamp holder included in the liquid crystal display device in FIG. 2. FIG. 6 is a perspective view illustrating a rear-side construction of the lamp holder. FIG. 7 is a magnified perspective view of a part of the lamp holder.

As illustrated in FIG. 1, the television receiver TV of the present embodiment includes the liquid crystal display device 10, front and rear cabinets Ca, Cb that house the liquid crystal display device 10 therebetween, a power source P, a tuner T and a stand S. An overall shape of the liquid crystal display device (display device) 10 is a landscape rectangular. The liquid crystal display device 10 is housed in a vertical position. As illustrated in FIG. 2, it includes a liquid crystal panel 11 as a display panel, and a backlight device 12 (a lighting device), which is an external light source. They are integrally held by a bezel 13 and the like.

Next, the liquid crystal panel 11 and the backlight device 12 included in the liquid crystal display device 10 will be explained (see FIGS. 2 to 4).

The liquid crystal panel (a display panel) 11 is constructed such that a pair of glass substrates is bonded together via liquid crystal that is sealed in a space provided with a predetermined gap between the glass substrates. On one of the glass substrates, switching components (e.g., TFTs) connected to source lines and gate lines that are perpendicular to each other, pixel electrodes connected to the switching components, and an alignment film are provided. On the other substrate, counter electrodes, color filter having color sections such as R (red), G (green) and B (blue) color sections arranged in a predetermined pattern, and an alignment film are provided. Polarizing plates 11a, 11b are attached to outer surfaces of the substrates (see FIGS. 3 and 4).

As illustrated in FIG. 2, the backlight device 12 includes a chassis 14, an optical member 15 and frames 16. The chassis 14 has a substantially box-shape and an opening 14b on the light output side (on the liquid crystal panel 11 side). The optical member is arranged so as to cover the opening 14b of the chassis 14. The optical member 15 includes a diffuser plate 15a arranged on a chassis 14 side. The frames 16 arranged along the long sides of the chassis 14 hold the long-side edges of the diffuser plate 15a to the chassis 14. The long-side edges of the diffuser plate 15a are sandwiched between the chassis 14 and the frames 16. Cold cathode tubes (light sources) 17, lamp clips 18, relay connectors 19 and lamp holders 20 are installed in the chassis 14. The lamp clips 18 are provided for mounting the cold cathode tubes 17 to the chassis 14. The relay connectors are connected to ends of the cold cathode tubes 17 for making electrical connection. The lamp holders (covering members) 20 collectively cover ends of the cold cathode tubes 17 and the relay connectors 19. In the backlight device 12, light is directed to a light output side, that is, to an area located on an optical member 15 side and more to the front than the cold cathode tubes 17. In this embodiment, a light-exiting portion 15z is provided on a light output side of the optical member 15 (i.e., on a liquid crystal panel 11 side).

The chassis 14 is made of metal. It includes a rectangular bottom plate and outer rim portions 21, each of which extends upright from the corresponding side of the bottom plate and has a substantially U shape. The outer rim portions 21 include short-side outer rims 21a and long-side outer rims 21b provided at the short sides and the long sides of the chassis 14, respectively. The bottom plate has a plurality of mounting holes 22, which are through holes, along the long-side edges thereof for mounting the relay connectors 19. As illustrated in FIG. 3, fixing holes 14c are provided on the upper surface of the chassis 14 along the long-side outer rims 21b to bind the bezel 13, the frames 16 and the chassis 14 together with screws and the like.

A light reflecting sheet 23 is disposed on an inner surface of the bottom plate of the chassis 14 (on a side that faces the cold cathode tubes 17). The light reflecting sheet 23 is a synthetic resin sheet having a surface in white that provides high light reflectivity. It is placed so as to cover almost entire inner surface of the bottom plate of the chassis 14. As illustrated in FIG. 3, long-side edges of the light reflecting sheet 23 are lifted so as to cover the long-side outer rims 21b of the chassis 14 and sandwiched between the chassis 14 and the diffuser plate 15a. With this light reflecting sheet 23, light emitted from the cold cathode tubes 17 is reflected toward the optical member 15.

Each cold cathode tube 17 is a linear light source having an elongated tubular shape. A plurality of the cold cathode tubes 17 are housed in the chassis 14. They are arranged parallel to each other (i.e., in a parallel arrangement) with the long-side direction (i.e., the axial direction) thereof aligned with the long-side direction of the chassis 14 (see FIG. 2). Each cold cathode tube 17 is slightly separated from the bottom plate of the chassis 14 (or the light reflecting sheet 23), and ends thereof are fitted to the respective relay connectors 19. The holders 20 are mounted so as to cover the relay connectors 19. The cold cathode tubes 17 have electrical terminals that are non-light-emitting portions at the ends thereof. The relay connectors 19 holding the ends of the cold cathode tubes 17 are covered by the lamp holders 20. As a result, shadows of the ends are less likely to be seen.

As illustrated in FIGS. 5 to 7, the lamp holders 20 are made of white synthetic resin. Each of them has an elongated substantially box shape that extends along the short side of the chassis 14 and covers the ends of the cold cathode tubes 17. As illustrated in FIG. 4, each lamp holder 20 has steps (a covering portion) 20z on the front side such that the diffuser plate (an optical sheet) 15a and the liquid crystal panel (an object to be illuminated) 11 are held at different levels. A part of the lamp holder 20 is placed on top of apart of the corresponding short-side outer rim 21a of the chassis 14 and forms a side wall of the backlight device 12 together with the short-side outer rim 21a. Insertion pins 24 project from a surface of the lamp holder 20 that faces the outer rim 21a of the chassis 14. The lamp holder 20 is mounted to the chassis 14 by inserting the insertion pins 24 into insertion holes 25 provided in the top surface of the short-side outer rim 21a of the chassis 14.

The steps 20z of each lamp holder 20 include three steps, surfaces of which are parallel to the bottom plate of the chassis 14. A short edge of the diffuser plate 15a is placed on the surface of the first step (an optical sheet supporting portion) 20a located at the lowest level. A sloped cover (a sloped portion) 26 extends from the first step 20a toward the bottom plate of the chassis 14. A short edge of the liquid crystal panel 11 is placed on a surface of the second step (an object supporting portion) 20b. A surface of the third step 20c located at the highest level is provided so as to overlap the short-side outer rim 21a of the chassis 14 and comes in contact with the bezel 13.

The steps 20z of each lamp holder 20 form a covering portion that is located above the upper surface of the cold cathode tubes 17 (on a light output side). Projections 71 project from the first step 20a toward the middle of the cold cathode tube 17, that is, the projections 71 extend from a side close to one of the ends of the cold cathode tubes 17 having a linear shape toward the midpoint thereof. Specifically, the projections 71 project toward the center of the backlight device 12 (more specifically, the center of the diffuser plate 15a that is placed on the first step 20a). The projections 71 project in the same plane as the first step (on the light output side) 20a of the steps (the covering portion) 20z. Each projection 71 has a supporting surface 71a in the same plane as the surface of the first step 20a. The supporting surface 71a can support the short-side edge of the diffuser plate 15a. As illustrated in FIG. 4, the diffuser plate 15a is supported by the surfaces of the projections 71 and the first step 20a of the steps 20z. Parts of the surface of the first step 20a protrude so as to form a plurality of protrusions 85 on the surface. The optical sheet 15 is placed on the protrusions 85. This configuration allows for deflection of the optical sheet even when the optical sheet 15 is bent, and thus the optical sheet 15 is properly supported.

The sloped cover 26 of each lamp holder 20 has cutouts 72 through which the cold cathode tubes 17 are inserted. The cutouts 72 are provided in the same number as the number of the cold cathode tubes 17. A part (or an end) of each cold cathode tube 17 inserted in the holder 20 from the cutout 72 is electrically connected to an inverter board (not shown). The sloped cover 26 projects from the first step 20a toward the middle of the cold cathode tube 17. The sloped cover 26 is located at a position lower than the projections 71. The projections 71 project within an area that overlaps the sloped cover 26 when viewed in plan. Namely, the projections 71 project within an area inner than distal end of the sloped cover and does not project outer than the sloped cover 26. The projections 71 are located at positions higher than the cutouts 72 so as to overlap the cold cathode tubes 17. They are provided symmetrically with a midpoint of the axis of the lamp holder 20 as a symmetrical point. By providing the projections 71 so as to overlap the cold cathode tubes 17, a problem related to visible shadows of the projections 71 is less likely to occur.

A difference in levels between the surfaces of the first step 20a and the second step 20b of the steps 20z of each lamp holder 20 is equal to an overall thickness of the optical sheet. Therefore, a gap between the liquid crystal panel 11 placed on the second step 20b and the optical sheet 15 is substantially zero. Namely, no fixing members exist between the liquid crystal panel 11 and the optical sheet 15 and thus an overall thickness of the liquid crystal display device 10 is reduced.

The optical member 15 configured to change characteristics of light emitted from the cold cathode tubes 17. The characteristics of light include an output angle and an in-plane luminance distribution. As illustrated in FIG. 2, the optical member 15 includes the diffuser plate 15a and an optical sheet set 15b. The optical sheet set 15b includes a lens sheet 15c, diffusing sheets 15d, 15e, 15f, 15g and a reflecting-type polarizing film 15h that are layered.

The diffuser plate 15a of the optical member 15 includes a synthetic resin plate in which light diffusing particles are scattered. The diffuser plate 15a diffuses linear light emitted from the cold cathode tubes 17, which are liner light sources (tubular light sources). The short-side edges of the diffuser plate 15a are placed on the first steps 20a of the lamp holders 20 as explained above. No force is applied to the edges to press them down. As illustrated in FIG. 3, the long-side edges of the diffuser plate (the prism diffuser plate) 15a are sandwiched between the chassis 14 (or the light reflecting sheet 23) and the frame 16 so as to be held tightly. Furthermore, elongated prisms are arranged parallel to each other on the front surface of the diffuser plate (the prism diffuser plate) 15a on the surface from which light exits (the light-exiting surface). The prisms are arranged such that the longitudinal direction thereof is parallel to that of the cold cathode tubes 17.

The optical sheet set 15b of the optical member 15 are sandwiched between the diffuser plate 15a and the liquid crystal panel 11. As explained above, the lens sheet 15c is arranged adjacent to the diffuser plate 15a on the light output side. The diffuser sheets 15d, 15e, 15f, 15g and the reflecting-type polarizing film 15h are layered on the lens sheet 15c. The lens sheet 15c includes a transparent substrate made of synthetic resin and elongated convex lenses (concave cylindrical lenses or lenticular lenses) arranged parallel to each other on the front surface (the light-exiting surface) of the substrate. The convex lenses are arranged such that the longitudinal direction thereof is parallel to that of the cold cathode tubes 17. Each of the diffusing sheets 15d, 15e, 15f, 15g includes a transparent substrate made of synthetic resin and a diffusing layer in which light diffusing particles are scattered. The polarizing film 15h passes some rays of light exiting from the diffuser sheets 15d, 15e, 15f, 15g and reflects the rest rays of the light. The diffusing layer is provided on the front surface of the substrate. The polarizing film 15h enhances the light use efficiency of the liquid crystal panel 11 for pixels.

In the backlight device 12 of the present embodiment, the cold cathode tubes 17 are arranged parallel to each other in space between the light reflecting sheet 23 on the inner surface of the chassis 14 and the diffuser plate 15a of the optical member 15. The space is referred to as a light source holding space (i.e., light source holding area). In this embodiment, each cold cathode tube 17 having a diameter of 4.0 mm is arranged in the following settings: a distance between the cold cathode tube 17 and the light reflecting sheet 23 is 0.8 mm, a distance between the adjacent cold cathode tubes 17 is 16.4 mm, and a distance between the cold cathode tube 17 and the diffuser plate 15a is 2.7 mm. In this backlight device 12, distances between the components are defined so as to reduce the thickness of the backlight device 12. Especially, the distance between the cold cathode tubes 17 and the diffuser plate 15a and the distance between the cold cathode tubes 17 and the reflecting sheet 23 are reduced. Because of the thickness reduction of the lighting device 12, the liquid crystal display device 10 and the television receiver TV are provided with the following thicknesses. The thickness of the liquid crystal display device 10 (i.e., the thickness between the front surface of the liquid crystal panel 11 and the back surface of the backlight device 12) is 16 mm. The thickness of the television receiver TV (i.e., and the thickness between the front surface of the front cabinet Ca and the back surface of the rear cabinet Cb) is 34 mm. Namely, a thin television receiver is provided.

According to the television receiver TV of the present embodiment having the above configurations, the lamp holders 20 of the backlight device 12 included in the liquid crystal display device 10 have a narrow width. Therefore, occurrences of the luminance increase or the uneven illumination around the edges are reduced. Each lamp holder 20 includes the projections 71 that project from the first step 20a of the covering portion 20z toward the midpoint of the axis of the cold cathode tube 17. The optical sheet 15 including the diffuser plate 15a is supported by the surfaces of the projections 71 and the first step 20a. Namely, the projections 71 provide additional supports for the diffuser plate 15a even when the supporting area of the first step 20a is reduced. Therefore, the supporting area of the first step 20a, that is, an area of the covering portion 20z or the width of each lamp holder 20 can be reduced as much as possible while the diffuser plate 15a is adequately supported. The areas of the lamp holders 20 that cover the ends of the cold cathode tubes 17 can be reduced while the diffuser plate 15a is adequately supported. Thus, occurrences of the illumination increase or the uneven illumination around the edges corresponding to the ends of the cold cathode tubes 17 can be reduced.

In this embodiment, each projection 71 has the supporting surface 71a in the same plane as the surface of the first step 20a. Therefore, the optical sheet is adequately supported by the surfaces of the first step 20a and the projections 71. Further, the liquid crystal panel 11 is placed on the surface of the second step 20b of the lamp holder 20. Namely, the distance between the backlight device 12 and the liquid crystal panel 11 is reduced as much as possible. As a result, the thickness of the liquid crystal display device 10 is reduced. To provide a simple configuration while the optical sheet 15 is arranged as close as possible to the liquid crystal panel 11, the liquid crystal panel 11 should be placed on the lamp holders 20. In this embodiment, each holder 20 has the second step 20b on which the liquid crystal panel 11 is placed. If the surface of the second step 20b is simply provided on the surface of the covering portion 20z on the light output side, the surface area of the first step 20a, on which the optical sheet 15 is placed, is reduced by the surface area of the second step 20b. As a result, the optical sheet 15 is not adequately supported. By providing the projections 71 in addition to the first step 20a, the optical sheet 15 is adequately supported even when the second step 20b, on which the liquid crystal panel is placed, is provided at a part of the lamp holder 20 to reduce the thickness of the display device. As a result, conflicting needs, namely, an adequate support of the optical sheet 15 and the reduction in thickness of the liquid crystal display device 10 can be achieved.

In this embodiment, the optical sheet 15 and the liquid crystal panel 11 are placed on the first step 20a and the second step 20b of the steps 20z, respectively. The difference in levels between the first step 20a and the second step 20b is defined so as to be equal to the thickness of the optical sheet 15. This makes the distance between the optical sheet 15 and the liquid crystal panel 11 as small as possible and thus the overall thickness of the liquid crystal display device 10 is reduced.

Furthermore, each lamp holder 20 has the sloped cover 26. The light emitted from the cold cathode tubes 17 is reflected off the sloped surface of the sloped cover 26 and directed toward the liquid crystal panel 11. Still furthermore, the projections 71 are provided above the sloped cover 26. The projections 71 extend from the first step 20a within the area that overlaps the sloped cover 26. With this structure, shadows of the projections are less likely to be projected and to affect on the illumination.

The present invention is not limited to the above embodiments explained in the above description. The following embodiments may be included in the technical scope of the present invention, for example.

(1) In the above embodiment, the projections 71 are provided above the cutouts 72 so as to overlap the cold cathode tubes 17. However, projections 171 illustrated in FIG. 8 may be provided between cutouts 72, 72. By providing the projections 171 between the cutouts 72, 72, that is, between the cold cathode tubes 17, 17, the projections 171 do not block the light from the cold cathode tubes and thus high light use efficiency can be achieved.
(2) In the second embodiment, the cold cathode tubes 17 are used as light sources. However, the light sources are not limited to the cold cathode tubes. Hot cathode tubes and other types of discharge tubes can be used.
(3) In the above embodiments, the projections 71 are provided symmetrically with the middle point of the axis of each lamp holder 20 as a symmetrical point. However, they may be provided asymmetrically. They may be provided only in the central area or only in the end areas. The projections 71 of the lamp holders 20 may be provided at equal intervals.

1. A lighting device comprising:
a light source including a conductive portion at an end thereof;
an optical sheet arranged on a light output side with respect to said light source;
a cover having light blocking effect and covering the end of the light source, said cover including a covering portion for covering said light source, an optical sheet supporting portion for supporting said optical sheet, the optical sheet supporting portion being provided on a light output side, and a projection projecting from said optical sheet supporting portion toward a middle of said light source.

2. The lighting device according to claim 1, wherein said projection has a surface in a same plane as a surface of said optical sheet supporting portion.

3. The lighting device according to claim 1, wherein:
said cover further includes an object supporting portion for supporting an object to be illuminated on a surface of said covering portion located on the light output side; and
said object supporting portion is located on the light output side with respect to said optical sheet supporting portion.

4. The lighting device according to claim 1, wherein:
said cover portion includes steps;
said optical sheet supporting portion corresponds to a first step of said steps; and
said object supporting portion corresponds to a second step of said steps.

5. The lighting device according to claim 1 further comprising a chassis, wherein:
said light source includes a plurality of linear light sources;
said chassis houses said linear light sources;
said linear light sources are provided in a parallel arrangement on an inner surface of said chassis;
said cover is mounted to an end area of said chassis so as to cover ends of said linear light sources;
said cover includes a sloped portion that extends from said covering portion toward the middle of said light source and sloped toward a bottom surface of said chassis; and
said projection projects within an area that overlaps said sloped portion.

6. The lighting device according to claim 1, wherein said cover has light reflectivity on a surface thereof.

7. A display device comprising:
the lighting device according to claim 1; and
a display panel configured to provide display using light from said lighting device.

8. The display device according to claim 7, wherein the said display panel is a liquid crystal display panel using liquid crystal.

9. A television receiver comprising the display device according to claim 7.
